(19) United States
(12) Patent Application Publication
(10) Pub. No.: US 2026/0212612 A1
(43) Pub. Date: Jul. 23, 2026

(54) CREATING A MIXED REALITY MEETING ROOM

(71) Applicant: Inter IKEA Systems B.V., DELFT (NL)

(72) Inventors: Jon ASPEHEIM, Osby (SE); Anders LUNDGREN, Halmstad (SE)

(73) Assignee: Inter IKEA Systems B.V., DELFT (NL)

(21) Appl. No.: 19/140,510

(22) PCT Filed: Dec. 20, 2023
(86) PCT No.: PCT/SE2023/051288

§ 371 Date: Jun. 18, 2025

(30) Foreign Application Priority Data
Dec. 22, 2022 (SE) 2251558-9

(51) Int. Cl. G06T 19/00

(52) U.S. Cl. CPC G06T 19/006; G06T 2210/56; G06T 2219/024

(57) ABSTRACT

A computer-implemented method (100) for creating a mixed reality (MR) meeting room (70) is provided. Two MR devices (10, 30) are configured to scan a respective physical object (22, 42) located in respective physical environments (40) in order to generate feature point clouds (24, 44) thereof. A feature point detection algorithm is applied thereto such that candidate anchor portions (55) are determined. The candidate anchor portions are compared to a reference feature point cloud (64), and at least one common anchor portion (50) is derived. The feature point clouds (24, 44) are aligned with respect to the common anchor portion (50), and the MR devices (10, 30) render visualization of the MR meeting room (70) based on the aligned feature point clouds (24, 44).

### TECHNICAL FIELD

The disclosure relates generally to mixed reality. More specifically, the disclosure relates to a computer-implemented method for creating a mixed reality meeting room. The disclosure also relates to an associated computerized system, a non-transitory computer-readable storage medium and a computing device.

### BACKGROUND

Mixed reality (MR) is a reality where physical and digital worlds meet. The MR spectrum covers human-environment-computer interactions extending from virtual reality (VR) to the physical reality, including the technical areas augmented reality (AR) and augmented virtuality (AV). Although the term MR was introduced already back in the 1990s, recent technology advancements in both hardware and software have enabled pioneering innovations in the field of MR. For instance, people may now virtually meet and interact with one another, despite being physically remotely located, in the digital world called the metaverse. With the assistance of human sensory systems and rules of human perception, MR offers users an immersive environment where real-time coordination between physical position and gesture are virtually reflected.

Although sharing certain aspects, the different areas of MR as described above require quite different technical solutions in order to function properly. This is especially the case for determining how objects in the environment should be viewed and placed (e.g., at which location and in which angle/orientation), and how virtual avatars (i.e., virtual representations of the users in the virtual world) should be placed and oriented in relation to said objects. The existing solutions of today for creating MR meeting rooms are unsatisfactory in various aspects, both in VR and AR.

When it comes to VR, the users do not see the physical world. Within the VR meeting room, the users may therefore be placed anywhere to participate in the experience. The users are typically represented in the form of virtual avatars that jointly participate in the virtual world. As an example, in a reference virtual world two users may simultaneously, or one after the other, be placed at a virtual reference location through their avatars. The virtual reference location can be any suitable surface, e.g., a floor surface, and the avatars can thus be placed as standing up (i.e., generally perpendicular to the floor surface).

Disadvantages with VR meeting rooms relate to the participating users directly recognizing that the environment is artificial, which negatively affects the immersiveness of the experience. It is therefore desired to provide an environment that as closely as possible resembles the physical environment of the user's room, both in terms of spatial surroundings (e.g., objects in the room) and spatial dimensions (e.g., the physical limitations confined by the room).

Providing an environment that as closely as possible resembles the physical environment of the user's room is more easily achievable with AR techniques. This is due to the fact that AR is built around the real world which is furnished by realistically rendered computer-generated imagery. In order to enable AR, the AR device and the software platform need to recognize something in the physical world and then build the AR experience around that. Specifically, in an AR experience it has to be determined where to place the content. For example, anchor-based AR relates to providing a plurality of different anchor types that can be used to place content, such as plane anchors, image anchors, face anchors, or 3D object anchors. The anchors ensure that the content in which the anchor is fixed to stays in position and orientation in the virtual space, thereby helping to maintain the illusion of virtual objects placed in the physical world. Anchors are typically used in conjunction with inside-out visual inertial SLAM tracking technology (viSLAM), that allows a robust tracking in frames where the anchors cannot reliably be detected. In marker-based AR, however, the AR content can only be displayed in direct relation to a fiducial marker having a pattern that uniquely identifies each marker. This allows for a simple tracking procedure, but only works as long as the marker is the camera view.

Similar to VR meeting rooms, AR meeting rooms are also associated with disadvantages. In particular, automatically achieving an accurate alignment and placement of two remote physical locations, all the physical objects associated therewith, as well as virtual avatars, is technically infeasible using the technology that is known as of today.

The present inventors have recognized the above-mentioned deficiencies of the prior art, and are herein presenting improvements that provide an immersive and interactive MR meeting room experience.

### SUMMARY

The present inventors are accordingly presenting the creation of a fully immersive MR meeting room, where two persons participating from two spatially different physical environments can meet. According to a first aspect of the disclosure a computer-implemented method for creating a mixed-reality (MR) meeting room is provided. The method comprises: by a first MR device, scanning a first physical object located in a first physical environment; by a second MR device, scanning a second physical object located in a second physical environment, the first and second physical environments being spatially different; during said scanning, generating first and second feature point clouds of the first and second physical objects, respectively, each one of the first and second feature point clouds comprising a plurality of feature points, each feature point having unique spatial coordinates with respect to the associated physical environment; applying a feature point detection algorithm to determine candidate anchor portions of each one of the first and second feature point clouds; comparing the candidate anchor portions to a reference feature point cloud of a virtual representation of a reference physical object; deriving, from among the candidate anchor portions, at least one common anchor portion between the first, second and reference feature point clouds in response to a matching condition of said comparing being met; aligning the first and second feature points clouds such that they coincide with one another with respect to the at least one common anchor portion; and by each one of the first and second MR devices, rendering visualization of the MR meeting room based on the aligned feature point clouds, such that a virtual representation of a user of the first MR device is visualized in the MR meeting room with respect to the second physical object, or a virtual representation thereof, and such that a virtual representation of a user of the second MR device is visualized in the MR meeting room with respect to the first physical object, or a virtual representation thereof.

In order to increase the coherency of the following disclosure, the term MR enabled object is introduced. An MR enabled object is to be interpreted as a physical object in which the MR meeting room is completely built around in terms of alignment and orientation of the MR meeting room, other physical and virtual objects to be included in the MR meeting room, and associated virtual avatars. The MR enabled object therefore serves as a spatially unrestricted object anchor from different physical locations. To this end, it is sufficient that respective MR enabled objects are physically located in the respective physical environments, and a corresponding reference physical object is digitally stored, to be able to enjoy an immersive and interactive MR meeting room experience thanks to the provisions of the invention according to the first aspect.

The invention according to the first aspect effectively utilizes the general idea that feature point cloud representations of similar MR enabled objects will resemble one another after having processed the respective feature points thereof. By comparing the candidate anchor portions to a feature point cloud of a virtual representation of a reference MR enabled object, a subsequent alignment procedure may thus be performed. The identification of candidate anchor portions of physical objects may be performed with a high accuracy with the objective of providing an immersive and interactive MR meeting room experience where practically any number of users may simultaneously participate. Hence, the benefits of a VR meeting room experience may be enjoyed in terms of accurate object orientation and alignment, while at the same time enjoying the realistic aspects of an AR meeting room experience.

The use cases for such an application are plural. Advantageously, any type of object that can be found in e.g., a home or office environment may represent the MR enabled object, as long as a corresponding MR enabled object is provided as the reference object. For instance, people wanting to sit in a sofa together and watch TV, play video games, or just have a normal realistic discussion face to face may use the sofa as the MR enabled object. In another example, people wanting to participate in a group training session may use a carpet or a yoga mat as the MR enabled object. In yet another example, people may want to play a board game, e.g., chess or similar, together by a table. In this case, either the table or the board game layout itself may serve as the MR enabled object. The skilled person will appreciate that a variety of different MR meeting experiences can additionally or alternatively be realized by means of the provisions according to the first aspect. Further technical advantageous effects may be realized in the embodiments/examples/appended claims described in the present disclosure.

In one or more embodiments, the reference physical object shares at least one physical property with the first and second physical objects.

In one or more embodiments, the at least one physical property is a texture, size, pattern, furniture type or another property by which a feature point cloud representation thereof is distinguishable from feature point cloud representations of other physical properties of the reference physical object.

In one or more embodiments, the matching condition is determined based on corresponding feature descriptor data of the at least one physical property.

In one or more embodiments, the feature point detection algorithm being a salient feature point detection algorithm.

In one or more embodiments, users of the first and second MR devices simultaneously participate in the MR meeting room.

In one or more embodiments, the method further comprising rendering visualization of virtual representations of one or more additional physical objects such that they are visualized in the MR meeting room with respect to the first physical object or the second physical object, or a virtual representation thereof.

In one or more embodiments, the MR meeting room is a virtual reality (VR) meeting room, wherein users of the first and second MR devices are virtually rendered as avatars and are virtually participating through their avatars in the VR meeting room, said avatars being visualized in the VR meeting room with respect to a virtual representation of the first physical object or the second physical object.

In one or more embodiments, the MR meeting room is an augmented reality (AR) meeting room, wherein a user of the first MR device is virtually rendered as an avatar and is virtually participating through the avatar in the AR meeting room, and wherein a user of the second MR device is physically participating in the AR meeting room.

In one or more embodiments, the rendering of a virtual representation of a user is performed based on spatial relationships between the user and the at least one common anchor portion, the virtual representation of the user thereby being visualized as spatially located in the MR meeting room with respect to the common anchor point.

In one or more embodiments, the at least one common anchor portion defines a spatial location and/or orientation of the MR meeting room.

In one or more embodiments, the first and second physical objects are selected from the group consisting of: home furnishing, home appliances, home equipment, office furnishing, office appliances and office equipment.

In one or more embodiments, the scanning is performed by a near real-time 3D scanning technique implemented by the MR devices.

In one or more embodiments, the feature points are voxels, each voxel having respective unique 3D coordinates.

In one or more embodiments, the MR meeting room is persistent.

According to a second aspect, a computerized system for creating a mixed reality (MR) meeting room is provided. The system comprises a first MR device, a second MR device and a backend service, wherein: the first MR device is configured to scan a first physical object located in a first physical environment; the second MR device is configured to scan a second physical object located in a second physical environment, the first and second physical environments being spatially different; wherein the respective MR devices, and/or the backend service, is/are further configured to: during said scanning, generate first and second feature point clouds of the first and second physical objects, respectively, each one of the first and second feature point clouds comprising a plurality of feature points, each feature point having unique spatial coordinates with respect to the associated physical environment; apply a feature point detection algorithm to determine candidate anchor portions of each one of the first and second feature point clouds; compare the candidate anchor portions to a reference feature point cloud of a virtual representation of a reference physical object; derive from among the candidate anchor portions, at least one common anchor portion between the first, second and reference feature point clouds in response to a matching condition of said comparing being met; and align the first and second feature points clouds such that they coincide with one another with respect to the at least one common anchor portion; and wherein each one of the first and second MR devices are further configured to render visualization of the MR meeting room based on the aligned feature point clouds, such that a virtual representation of a user of the first MR device is visualized in the MR meeting room with respect to the second physical object, or a virtual representation thereof, and such that a virtual representation of a user of the second MR device is visualized in the MR meeting room with respect to the first physical object, or a virtual representation thereof.

In one or more embodiments, the MR meeting room is persistent.

In one or more embodiments, the first and second MR devices are selected from the group consisting of: a head mounted display (HMD), a cave automatic virtual environment (CAVE) or an augmented reality (AR) device.

In a third aspect, a non-transitory computer-readable storage medium is provided. The non-transitory computer-readable storage medium comprises instructions, which when executed by a processor device, cause the processor device to perform the functionality of one of the first or second MR device of the method of the first aspect.

In a fourth aspect, a computing device is provided. The computing device comprises a processor device being configured to perform the functionality of one of the first or second MR device of the method of the first aspect.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 is an exemplary illustration showing the creation of an MR meeting room.

FIG. 2 is an exemplary schematic diagram illustrating data relating to the creation of an MR meeting room.

FIG. 3A is an exemplary schematic diagram illustrating a computerized system which may be configured to create an MR meeting room.

FIG. 3B is an exemplary computing environment for the computerized system of FIG. 3A.

FIG. 4 is an exemplary flowchart method for creating an MR meeting room.

FIG. 5 is an exemplary computer-readable storage medium.

### DETAILED DESCRIPTION

Aspects set forth below represent the necessary information to enable those skilled in the art to practice the disclosure.

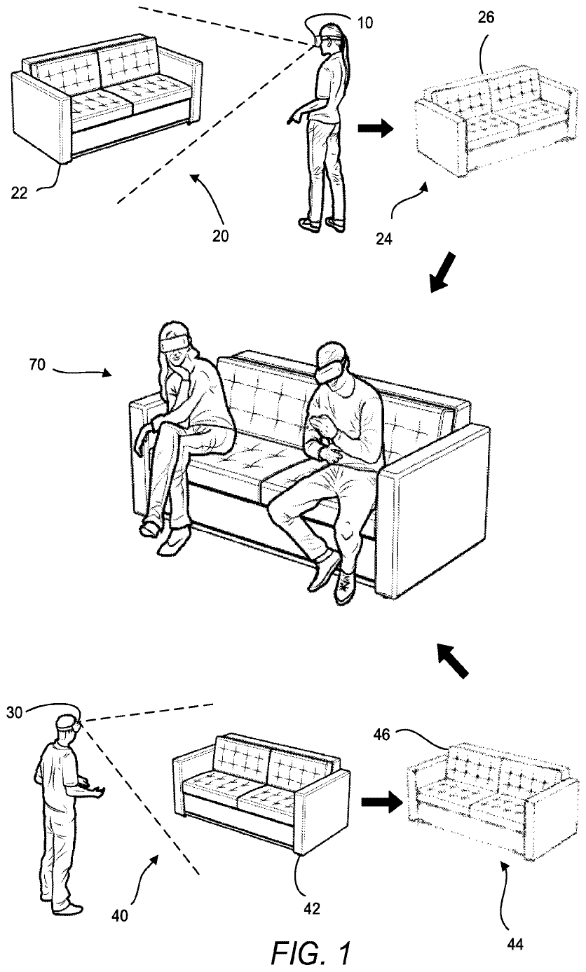

FIG. 1 is an exemplary illustration of the creation of an MR meeting room 70. Seen in the figure is a first person wearing a first MR device 10 in a first physical environment 20. A second person is also shown wearing a second MR device 30 in a second physical environment 40. The physical environments 20, 40 are spatially different, meaning that they are distinct environments located at remote physical locations. For instance, the first environment 20 may be the home/office of the first person and the second environment 40 the home/office of the second person, where the two persons live or work at different addresses, cities or even countries.

Each one of the MR devices 10, 30 are scanning respective physical objects 22, 42 located in the respective physical environments 20, 40. As described in the Summary section, the physical objects 22, 42 are MR enabled objects. The physical objects 22, 42 are not limited to a particular type of object. In this example, the physical objects 22, 42 are sofas. Some other use cases were described in the Summary section where the physical objects 22, 42 were carpets, yoga mats, tables or game boards. Any other objects typically found within a suitable environment, e.g. home, office, restaurant, hotel, school, coffee shop, park or beach environment, to name a few examples, may alternatively be used as an MR enabled object. In some examples, the physical objects 22, 42 are selected from the group consisting of: home furnishing, home appliances, home equipment, office furnishing, office appliances and office equipment. In this regard, furnishing, appliances and equipment are to be construed in the broadest possible sense, i.e., bicycles, musical instruments, stuffed animals, curtains, fireplaces, lamps, and so forth, can all be considered as candidates for the physical objects 22, 42. Clearly, home and office appliances, furnishing and/or equipment may be found in other locations than in the home/office, e.g., in restaurants, hotels, schools, coffee shops, parks or beaches, to name a few examples.

The physical objects 22, 42 may share at least one physical property. A physical property may be a texture, size, pattern, furniture type or color, to name a few physical properties. The physical properties may be visually distinguishable by the persons operating the MR devices 10, 30.

The scanning may be based on any known scanning technology known in the art, such as a near real-time 3D scanning tool. Such tools may include LiDAR, stereo camera systems, depth camera systems, structured light projection systems, to name a few examples. Alternatively, the scanning may be based on photogrammetry software.

During said scanning, respective feature point clouds 24, 44 of the first and second physical objects 22, 42 are generated. A feature point cloud is, as such, a known concept to the person skilled in the art. Each one of the feature point clouds 24, 44 comprises a plurality of feature points 26, 46, each feature point 26, 46 having unique spatial coordinates (e.g., Cartesian coordinates x, y, z) with respect to the associated physical environment 20, 40.

Generating the feature point clouds 24, 44 based on the scanning may be based on any known feature point generation technique known in the art, such as the 3D scanning techniques or photogrammetry techniques mentioned above. The result of the scanning is shown in FIG. 1, where each physical object 22, 42 is digitally represented as the feature points, 26, 46. The feature points 26, 46 may be represented as voxels, where each voxel comprises respective unique 3D coordinates with respect to the respective physical environments 20, 40.

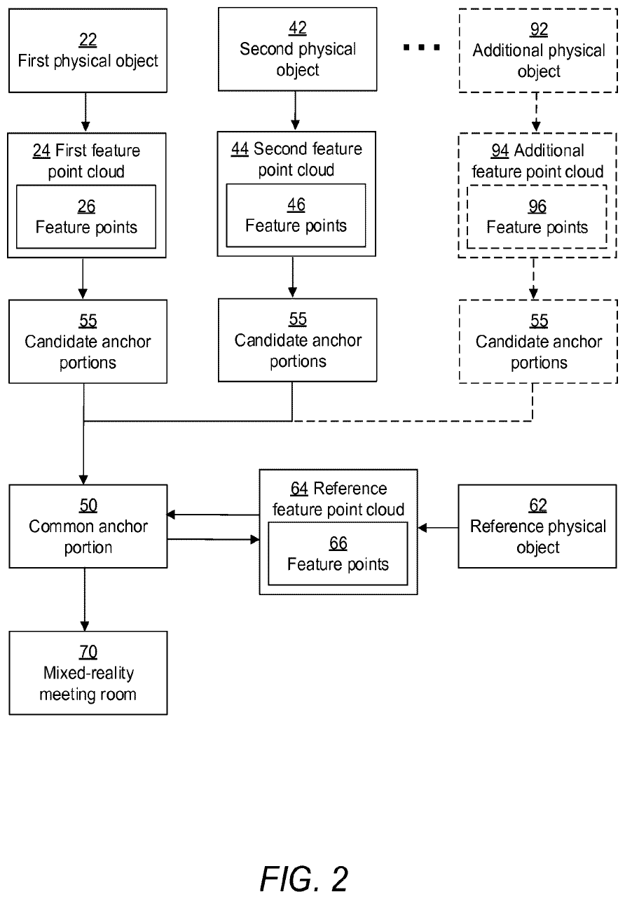

Further seen in FIG. 1 is the MR meeting room 70. Visualization of the MR meeting room 70 is generated by each one of the MR devices 10, 30. Before said visualization of the MR meeting room 70 is rendered, several actions first need to be performed, actions which will be described in more detail later on in this disclosure with further reference to FIG. 2.

The MR devices 10, 30 will render different visualizations of the MR meeting room 70, depending on different factors. In some examples, both of the users of the MR devices 10, 30 experience the MR meeting room 70 simultaneously as if both of them are being visited by the other one (i.e., both users are “visitees”). Hence, both of the users of the MR devices 10, 30 will see the other user being represented as a virtual avatar, but located in the user's own home. It is thus possible for both of the users to experience a virtual visit by the other user, at the same time. In some examples, one of the users is the visitee and the other user that is the visitor.

The MR meeting room 70 may be persistent. Persistency in the MR meeting room 70 involves extending the existence of digital content beyond when the system is actually used, such that the content is given a permanent place in the MR meeting room 70. To this end, the MR meeting room 70 may comprise a plurality of meeting room sessions. This allows users of the MR meeting room 70 to join or exit the virtual world without progress being lost. For instance, in a digital painting session where a real canvas is used as the physical object 22 or 42, the current progress made by the artist may be resumed at any time despite possibly jumping in and out of an MR meeting room session. Persistency may alternatively be provided for any other objects in a VR meeting room, i.e., not necessarily the MR-enabled object.

In some examples, although not explicitly shown in FIG. 1, visualization of virtual representations of one or more additional physical objects may be rendered. These virtual representations are visualized in the MR meeting room 70 using the first physical object 22, or a virtual representation thereof, or the second physical object 42, or a virtual representation thereof, as a reference.

The MR meeting room 70 may be a VR meeting room. In examples where the MR meeting room 70 is a VR meeting room, both users are virtually rendered as virtual avatars and are virtually participating through their avatars in the VR meeting room. Both of the users will thus view a completely virtual world which is closely resembling the real physical environment of either one of the users. Alternatively, the virtual world may comprise features that are common for both of the respective physical worlds, for instance a merging of certain physical aspects. The visualization of the avatars is based on a virtual representation of the first physical object 22 or the second physical object 42. Because of the VR meeting room being completely virtual, the sofa is rendered as a “visually perfect” sofa (in more general examples simply a “visually perfect object”).

The MR meeting room 70 may be an AR meeting room. In examples where the MR meeting room 70 is an AR meeting room, the respective users are represented differently depending on which one of the MR devices 10, 30 that is rendering the MR experience. From the perspective of the MR device 10, the other user will be virtually rendered as a virtual avatar and is virtually participating in the AR meeting room through the virtual avatar, and vice versa from the perspective of the MR device 30. In other words, both of the users will experience the other user as a virtual avatar located in their “own” physical environment.

The MR meeting room 70 may be a combined AR and VR meeting room. To this end, a user of the MR device 10 may experience a VR meeting room, while a user of the MR device 30 may experience an AR meeting room.

In view of the above, the MR meeting room 70 is “cross-rendered”, i.e., rendered for all of the participating users by a respective MR device 10, 30, but not necessarily rendered the same way.

Thus, in contrast with the prior art, the disclosed MR meeting room 70 achieves accurate alignment and placement of two remote physical locations 20, 40 and physical objects 22, 42, as well as users (or virtual avatars of the users), associated therewith.

In FIG. 2, a schematic illustration of data relating to the creation of an MR meeting room 70 is shown. The scanning of first and second physical objects 22, 42 to create respective feature point clouds 24, 44, each having a set of feature points 26, 46, in order to create the MR meeting room 70, was at least conceptually explained with reference to FIG. 1. More technical details and implications will now be further elaborated upon. As indicated in FIG. 2, any number of additional users may partake in the experience provided by the MR meeting room 70 through the scanning of an additional physical object 92 and the generation of corresponding subsequent data, the data being an additional feature point cloud 94 and associated feature points 96, as well as additional candidate anchor portions 55. To this end, it is understood that a visitee of the MR meeting room 70 may be visited by any number of visitors.

Candidate anchor portions 55 are determined in the present disclosure. This determination, in combination with the deriving of at least one common anchor portion 50, dictates how the anchoring procedure of the respective virtual representations of the physical objects 22, 42, 92 with respect to one another is to be performed. Hence, it enables the MR meeting room 70 to be aligned and the associated MR experience to be enjoyed by the participating users, i.e., the visitee and any number of visitors.

“Portions” as used with reference to the candidate anchor portions 55 and the at least one common anchor portion 50 is to be broadly interpreted. The portions 50, 55 may be the smallest portion of the feature point clouds 24, 44, 94 that is distinguishable from other portions of the feature point clouds 24, 44, 94. The portions 50, 55 may alternatively be a bigger portion of the feature point clouds 24, 44, 94, for instance corresponding to a cushion, armrest or neckrest of the sofa, or even the entire sofa if this is required in order to make a distinction of salient information thereof. The portions 50, 55 may also be any size in between the smallest and biggest portions as described above.

In order to determine the candidate anchor portions 55, feature descriptor data of the feature point clouds 24, 44, 94 may be computed. Feature descriptor data may comprise edges. Edges correspond to identifiable boundaries between different image regions of the feature point clouds 24, 44, 94. Feature descriptor data may comprise corners. Corners correspond to identifiable rapid changes in direction of image regions of the feature point clouds 24, 44, 94. Feature descriptor data may comprise blobs. Blobs correspond to local maximum of an image region or a center of gravity of feature points therein of the feature point clouds 24, 44, 94. Feature descriptor data may comprise ridges. Ridges correspond to one-dimensional curves that represents an axis of symmetry within the feature point clouds 24, 44, 94. Other suitable feature descriptor data may alternatively be used to determine the candidate anchor portions 55.

Computing the feature descriptor data may be done by applying a feature point detection algorithm. The feature point detection algorithm is configured to compute information of the feature point clouds 24, 44, 94 and decide whether a specific feature point 26, 46, 96 corresponds to an image feature of a given type. Such image features of a given type may correspond to salient information of the respective physical objects 22, 42, 92, i.e., information considered to be of interest. Obtaining salient information may thus be done by applying a salient feature point detection algorithm. The salient information may be indicative of a physical property, such as a texture, size, pattern, furniture type or another property by which a feature point cloud representation thereof is distinguishable from feature point cloud representations of other physical properties of the physical object 22, 42, 92.

Although there is no widely acknowledged definition introduced in the art for what is considered to constitute objects of interest for a feature point detection algorithm, it is generally understood that some feature descriptor data is easier to detect than others, hence the definitions according to the above relating to ridges, corners, blobs, and edges, etc. The feature detection algorithm performs low-level image processing operations, generally at pixel level (or subsets of pixels). Hence, repeatability is preferably achieved at pixel level, i.e., that a common feature can be detected in different feature point clouds 24, 44, 94. Different algorithms known in the art handle this differently, and the present disclosure is not limited to one particular type of feature point detection algorithm. Some exemplary algorithms that can be applied may be one of SIFT (scale-invariant feature transform), edge detection, FAST (features from accelerated segment test), level curve curvature, Canny edge detector, Sobel-Feldman operator, corner detection (e.g., Hessian strength feature measures, SUSAN, Harris corner detector, level curve curvature or Shi & Tomasi), blob detection (e.g., Laplacian of Gaussian, Determinant of Hessian or Grey-level blobs), Difference of Gaussians, MSER (maximally stable extremal regions), ridge detection (e.g., Principal curvature ridges), to name a few examples.

As has been discussed herein, the physical objects 22, 42, 92 are objects typically found in a home, office, restaurant, hotel, school, coffee shop, park or beach environment, to name a few exemplary environments. Hence, the feature point clouds thereof 24, 44, 94 vary depending on what type of object it is, and also the corresponding detectability of the applied feature point detection algorithm. Some algorithms may therefore work better for some type of objects than others, and this is determined based on a variety of different factors, such as texture, pattern, furniture type, and/or another distinguishable physical property.

For example, the texture solid wood is more easily distinguishable from the texture mirror surface, as it comprises more structural details which are inherently determined by the wood material. The corresponding feature descriptor data of the feature point cloud representation of e.g., a table based on solid wood may thus contain more distinguishable ridges, corners, blobs, edges and curves compared to feature descriptor data of the feature point cloud representation of a mirror. The accuracy of the determination of the candidate anchor portions 55 is therefore better when the physical object 22, 42, 92 is a wooden table compared to a mirror. Similar examples can be realized for other physical properties, such as a flowery sofa (more distinguishable feature descriptor data) compared to a uniformly colored sofa (less distinguishable feature descriptor data), or a chair with a high number of sharp corners/edges (more distinguishable feature descriptor data) compared to a more smoothly cornered chair (less distinguishable feature descriptor data). To this end, it is understood that the alignment of the MR meeting room 70 will be more accurate for some physical objects 22, 42, 92 than others.

Once the candidate anchor portions 55 have been determined, one or more common denominators between all of the candidate anchor portions 55 are to be determined as the at least one common anchor portion 50. This is done by comparing the candidate anchor portions 55 to reference information. The reference information is a reference feature point cloud 64 of a virtual representation of a reference physical object 62. The virtual representation of the reference physical object 62 is a 3D model of a physical object that resembles the physical objects 22, 42, 92, i.e., a virtual representation of an MR enabled object. The reference physical object 62 may share at least one physical property with the physical objects 22, 42, 92, and may thus comprise corresponding distinguishable feature descriptor data of physical properties.

The at least one common anchor portion 50 is derived from among the candidate anchor portions 55 in response to a matching condition being met. The matching condition may be based on feature descriptor data of the at least one physical property of the virtual representation of the reference physical object 62, i.e., salient features of the reference feature point cloud 64. The feature descriptor data of the reference feature point cloud 64 may be obtained from a model file of the reference physical object 62. The model file may be a CAD file, e.g., STEP, QIF, JT or 3D PDF, a mesh representation, e.g., OBJ, GLTF, etc., a neural radiance field model, or other data-readable files, e.g., json, yaml, xml, to name a few examples. The feature descriptor data of the reference feature point cloud 64 may also be retrieved as previous scan samples of a physical object.

By way of deriving the candidate anchor portion 55 using the comparison as explained above, a very high confidence can be provided in the match. The matching condition may be set accordingly. The matching condition is configured to determine what must be satisfied for one or more of the candidate anchor portions 55 to be considered common. The matching condition may be set at an arbitrary percentage-based value, e.g., 80%, 90%, 95%, and so forth. The matching condition may be set differently depending on what physical properties are being compared and how they are compared. For instance a certain texture yielding a specific ridge may require a 99% match to establish a common portion, while a certain size of a physical object yielding specific corners/edges may only require a 60% match to establish a common portion. The matching condition may depend on the number of candidate anchor portions 55 being compared. A higher number of resembling candidate anchor portions 55 may thus be indicative of a more likely match and thus a more confident determination of the common anchor portion(s) 50.

Once the at least one common anchor portion 50 has been derived, the feature point clouds 24, 44, 94 are aligned with respect to said anchor portion 50, such that they coincide with one another. The alignment may be performed by aligning arrays of the feature point clouds 24, 44, 94 into one aligned feature point cloud using a 3D rigid or affine geometric transformation algorithm. A box grid filter may be applied to the aligned feature point cloud having 3D boxes of a specific size. Feature points 26, 46, 96 within same box grids may be merged to a single point. For the alignment purposes, a feature point cloud alignment algorithm may be applied. Some exemplary algorithms that can be applied may be one of ICP (Iterative Closest Point), CPD (Coherent Point Drift), NDT (Normal-Distributions Transform), FCGF (Fully Convolutional Geometric Features), D3Feat (Joint Learning of Dense Detection and Description of 3D Local Features), PREDATOR (pairwise point cloud registration with deep attention to the overlap region), PointNet-LK (Point Network Lucas & Kanade), PCRNet (Point Cloud Registration Network), DCP (Deep Closest Point), DGR (Deep Global Registration), PRNet (Partial Registration Network), RPMNet (Robust Point Matchning Network), to name a few examples.

The final step of the procedure is to perform the rendering of the MR meeting room 70. The rendering of the MR meeting room 70 may be performed by any 3D graphics rendering software known in the art, none of which are to be interpreted as limiting. Suitable rendering software may be provided by Unity, ARKit, Unreal Engine, OctaneReader, 3DSMax, V-Ray, Corona Renderer, Maxwell Ray, to name some examples.

The rendering of the virtual representations of the user(s) may be performed based on spatial relationships between the user(s) and the at least one common anchor point 50. The virtual representations of the users are thus spatially located in the MR meeting room 70 with respect to the common anchor portion 50. The at least one common anchor portion 50 may define a spatial location and/or orientation of the MR meeting room 70. Hence, the MR world is built around the at least common anchor portion 50, and the virtual content of the world (including e.g., virtual representations of users and objects) is virtually placed in spatial relation to the common anchor portion 50.

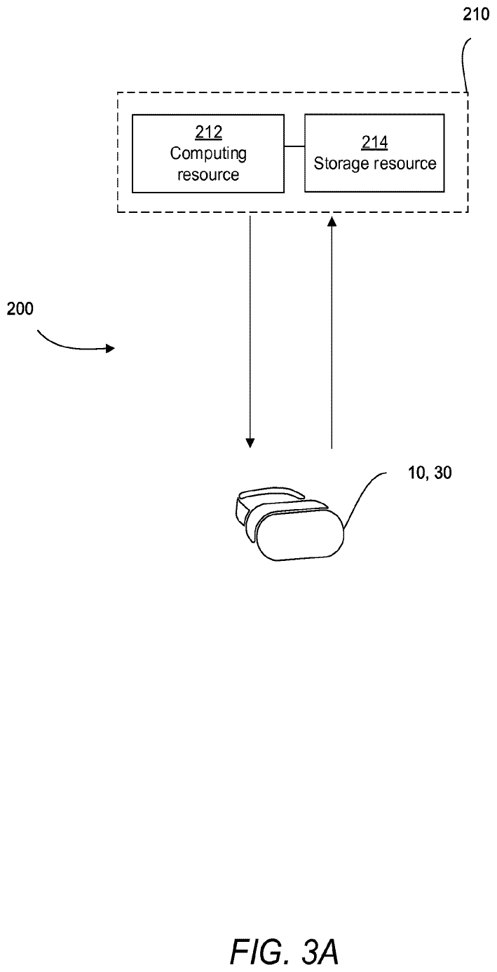

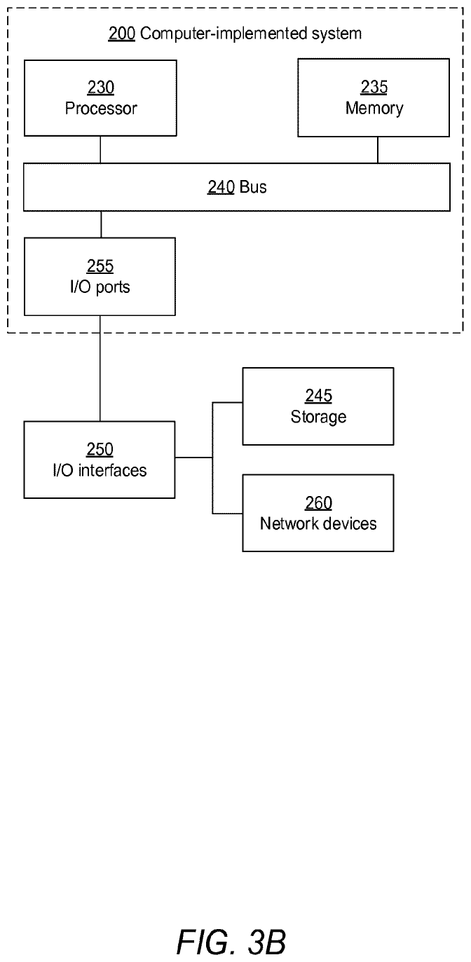

FIG. 3A is an exemplary schematic diagram illustrating a computerized system 200 which may be configured to create an MR meeting room. The computerized system 200 comprises a server-side platform 210 and two MR devices 10, 30.

The MR devices 10, 30 are in the provided example head-mounted displays (HMDs). In other examples, the MR devices 10, 30 may be any type of computing device known in the art. The computing device may be an AR device, such as a smart tablet, a smartphone, a laptop computer, a smartwatch, smart glasses or a Neuralink chip. The computing device may be a CAVE virtual environment.

The server-side platform 210 may be hosted on a cloud-based server being implemented using any commonly known cloud-computing platform technologies, such as Amazon Web Services, Google Cloud Platform, Microsoft Azure, DigitalOcean, Oracle Cloud Infrastructure, IBM Bluemix or Alibaba Cloud. The cloud-based server may be included in a distributed cloud network that is widely and publicly available, or alternatively limited to an enterprise. Alternatively, the cloud-based server may in some embodiments be locally managed as e.g., a centralized server unit. Other alternative server configurations may be realized, based on any type of client-server or peer-to-peer (P2P) architecture. Server configurations may thus involve any combination of e.g. web servers, database servers, email servers, web proxy servers, DNS servers, FTP servers, file servers, DHCP servers, to name a few.

The server-side platform 210 comprises a computing resource 212 and a storage resource 214 being in operative communication. The computing resource 212 is configured to perform processing activities as discussed in the present disclosure, such as generating feature point clouds, applying a feature point detection algorithm, comparing candidate anchor portions to a reference feature point cloud, deriving at least one common anchor portion and aligning the feature point clouds. To this end, the computing resource 212 comprises one or more processor devices configured to process data associated with the creation of the MR meeting room.

The storage resource 214 may be maintained by and/or configured as a cloud-based service, being included with or external to the computing resource 110. Connection to the storage resource 214 may be established using DBaaS (Database-as-a-service). For instance, the storage resource 214 may be deployed as a SQL data model such as MySQL, PostgreSQL or Oracle RDBMS. Alternatively, deployments based on NoSQL data models such as MongoDB, Amazon DynamoDB, Hadoop or Apache Cassandra may be used. DBaaS technologies are typically included as a service in the associated cloud-computing platform.

The MR devices 10, 30 is configured to perform processing activities as discussed in the present disclosure, such as scanning the physical environments and rendering visualization of the MR meeting room. In some examples, the MR devices 10, 30 may also be configured to perform the functionality as described with reference to the computing resource 212. In yet some examples, both the MR devices 10, 30 and the computing resource 212 may be configured to perform the different functionalities as described herein.

Communication between the server-side platform 210 and the MR devices 10, 30 may be enabled by means of any short-range or long-range wireless communication standards known in the art. For instance, the wireless communication may be enabled by technologies included but not limited to IEEE 802.11, IEEE 802.15, ZigBee, WirelessHART, WiFi, Bluetooth®, BLE, RFID, WLAN, MQTT IOT, CoAP, DDS, NFC, AMQP, LoRaWAN, Z-Wave, Sigfox, Thread, EnOcean, mesh communication, any form of proximity-based device-to-device radio communication, LTE Direct, W-CDMA/HSPA, GSM, UTRAN, LTE or Starlink.

As shown in FIG. 3B, the computerized system 200 may include a number of units known to the skilled person for implementing the functionalities as described in the present disclosure. The computerized system 200 may comprise one or more computing units capable of including firmware, hardware, and/or executing software instructions to implement the functionality described herein. The computerized system 200 may comprise one or more processor devices (may also be referred to as a control unit) 230, one or more memories 235 and one or more buses 240. The processor devices 230 may be included in the computing devices 222a-e and the computing resource 212, respectively. The computerized system 200 may include at least one computing device having the processor device 230. A system bus 240 may provide an interface for system components including, but not limited to, the memories 235 and the processor devices 230. The processor device 230 may include any number of hardware components for conducting data or signal processing or for executing computer code stored in the memories. The processor device 230 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device 230 may further include computer executable code that controls operation of the programmable device.

The system bus 240 may be any of several types of bus structures that may further interconnect to a memory bus (with or without a memory controller), a peripheral bus, and/or a local bus using any of a variety of bus architectures. The memories 235 may be one or more devices for storing data and/or computer code for completing or facilitating methods described herein. The memories 235 may include database components, object code components, script components, or other types of information structure for supporting the various activities herein. Any distributed or local memory device may be utilized with the systems and methods of this description. The memories 235 may be communicably connected to the processor device 230 (e.g., via a circuit or any other wired, wireless, or network connection) and may include computer code for executing one or more processes described herein. The memories may include non-volatile memories (e.g., read-only memory (ROM), erasable programmable read-only memories (EPROM), electrically erasable programmable read-only memories (EEPROM), etc.), and volatile memories (e.g., random-access memory (RAM)), or any other medium which can be used to carry or store desired program code in the form of machine-executable instructions or data structures and which can be accessed by a computer or other machine with a processor device. A basic input/output system (BIOS) may be stored in the non-volatile memories and can include the basic routines that help to transfer information between elements within the computer system.

A storage 245 may be operably connected to the computerized system 200 via, for example, I/O interfaces (e.g., card, device) 250 and I/O ports 255. The storage 245 can include, but is not limited to, devices like a magnetic disk drive, a solid state drive, an optical drive, a flash memory card, a memory stick, etc. The storage 245 may also include a cloud-based server implemented using any commonly known cloud-computing platform, as described above. The storage 245 or memory 235 can store an operating system that controls and allocates resources of the computerized system 200.

The computerized system 200 may interact with network devices 260 via the I/O interfaces 250, or the I/O ports 255. Through the network devices 260, the computerized system 200 may interact with a network. Through the network, the computerized system 200 may be logically connected to remote computers. Through the network, the server-side platform 210 may communicate with the client-side platform 220, as described above. The networks with which the computerized system 200 may interact include, but are not limited to, a local area network (LAN), a wide area network (WAN), and other networks.

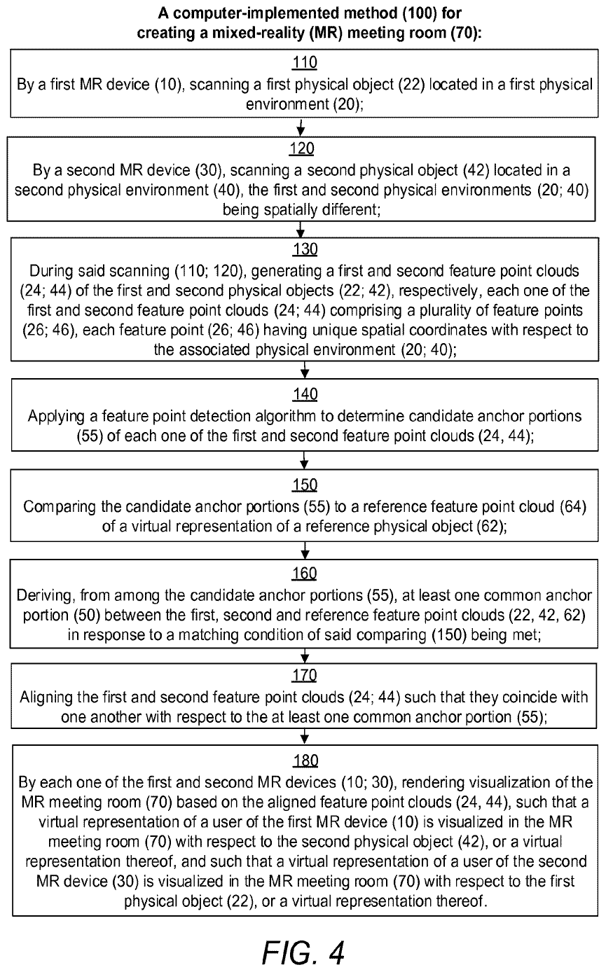

FIG. 4 shows an exemplary method 100 for creating an MR meeting room 70. The method 100 involves, by a first MR device 10, scanning a first physical object 22 located in a first physical environment 20. The method 100 further involves, by a second MR device 30, scanning a second physical object 42 located in a second physical environment 40, wherein the first and second physical environments 20, 40 are spatially different. The method 100 further involves, during the scanning 110, 120, generating a first and second feature point cloud 24, 44 of the first and second physical objects 22, 42, respectively. Each one of the first and second feature point clouds 24, 44 comprises a plurality of feature points 26, 46, each feature point having unique spatial coordinates with respect to the associated physical environment 20, 40. The method 100 further involves applying 140 a feature point detection algorithm to determine candidate anchor portions 55 of each of the first and second feature point clouds 24, 44. The method 100 further involves comparing 150 the candidate anchor portions 55 to a reference feature point cloud 64 of a virtual representation of a reference physical object 62. The method 100 further involves deriving 160, from among the candidate anchor portions 55, at least one common anchor portion 50 between the first, second and reference feature point clouds 22, 42, 62 in response to a matching condition of said comparing 150 being met. The method 100 further involves aligning 170 the first and second feature point clouds 24, 44 such that they coincide with one another with respect to the least one common anchor portion 55. The method 100 further involves, by each one of the first and second MR devices 10, 30, rendering 180 visualization of the MR meeting room 70 based on the aligned feature point clouds 24, 44. The rendering 180 is done such that a virtual representation of a user of the first MR device 10 is visualized in the MR meeting room 70 with respect to the second physical object 42, or a virtual representation thereof, and such that a virtual representation of a user of the second MR device 30 is visualized in the MR meeting room 70 with respect to the first physical object 22, or a virtual representation thereof.

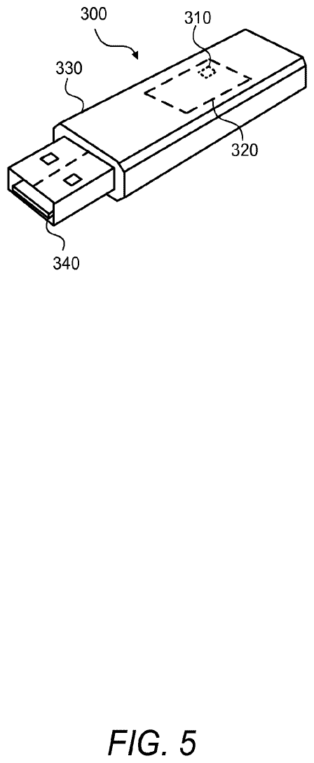

With reference to FIG. 5, a schematic illustration of a (non-transitory) computer-readable (storage) medium 300 is shown according to one exemplary embodiment. The computer-readable medium 300 may be associated with or connected to the computerized system 200 as described herein, and is capable of storing a computer program product 310. The computer-readable medium 300 in the disclosed embodiment is a memory stick, such as a Universal Serial Bus (USB) stick. The USB stick 300 comprises a housing 330 having an interface, such as a connector 340, and a memory chip 320. In the disclosed embodiment, the memory chip 320 is a flash memory, i.e., a non-volatile data storage that can be electrically erased and re-programmed. The memory chip 320 stores the computer program product 310 which is programmed with computer program code (instructions) that when loaded into a processor device, will perform a method, for instance the method 100 explained with reference to FIG. 4. The USB stick 300 is arranged to be connected to and read by a reading device for loading the instructions into the processor device. It should be noted that a computer-readable medium can also be other mediums such as compact discs, digital video discs, hard drives or other memory technologies commonly used. The computer program code (instructions) can also be downloaded from the computer-readable medium via a wireless interface to be loaded into the processing device.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for creating a mixed-reality meeting room, comprising:
by a first MR device scanning first physical object located in a first physical environment;
by a second MR device, scanning second physical object located in a second physical environment, the first and second physical environments being spatially different;
during said scanning, generating first and second feature point clouds of the first and second physical objects, respectively, each one of the first and second feature point clouds comprising a plurality of feature points each feature point having unique spatial coordinates with respect to the associated physical environment;
applying a feature point detection algorithm to determine candidate anchor portions of each one of the first and second feature point clouds;
comparing the candidate anchor portions to a reference feature point cloud of a virtual representation of a reference physical object;
deriving, from among the candidate anchor portions, at least one common anchor portion between the first, second and reference feature point clouds in response to a matching condition of said comparing being met;
aligning the first and second feature points clouds such that they coincide with one another with respect to the at least one common anchor portion; and
by each one of the first and second MR devices rendering visualization of the MR meeting room based on the aligned feature point clouds, such that a virtual representation of a user of the first MR device is visualized in the MR meeting room with respect to the second physical object, or a virtual representation thereof, and such that a virtual representation of a user of the second MR device is visualized in the MR meeting room with respect to the first physical object, or a virtual representation thereof.

2. The computer-implemented method according to claim 1, wherein the reference physical object shares at least one physical property with the first and second physical objects.

3. The computer-implemented method according to claim 2, wherein the at least one physical property is a texture, size, pattern, furniture type or another property by which a feature point cloud representation thereof is distinguishable from feature point cloud representations of other physical properties of the reference physical object.

4. The computer-implemented method according to claim 2, wherein the matching condition is determined based on corresponding feature descriptor data of the at least one physical property.

5. The computer-implemented method according to claim 1, the feature point detection algorithm being a salient feature point detection algorithm.

6. The computer-implemented method according to claim 1, wherein users of the first and second MR devices simultaneously participate in the MR meeting room.

7. The computer-implemented method according to claim 1, further comprising rendering visualization of virtual representations of one or more additional physical objects such that they are visualized in the MR meeting room with respect to the first physical object or the second physical object, or a virtual representation thereof.

8. The computer-implemented method according to claim 1, wherein the MR meeting room is a virtual reality (VR) meeting room,
wherein users of the first and second MR devices are virtually rendered as avatars and are virtually participating through their avatars in the VR meeting room, said avatars being visualized in the VR meeting room with respect to a virtual representation of the first physical object or the second physical object.

9. The computer-implemented method according to claim 1, wherein the MR meeting room is an augmented reality meeting room,
wherein a user of the first MR device is virtually rendered as an avatar and is virtually participating through the avatar in the AR meeting room, and
wherein a user of the second MR device is physically participating in the AR meeting room.

10. The computer-implemented method according to claim 1, wherein the rendering of a virtual representation of a user is performed based on spatial relationships between the user and the at least one common anchor portion, the virtual representation of the user thereby being visualized as spatially located in the MR meeting room with respect to the common anchor point.

11. The computer-implemented method according to claim 1, wherein the at least one common anchor portion defines a spatial location and/or orientation of the MR meeting room.

12. The computer-implemented method according to claim 1, wherein the first and second physical objects are selected from the group consisting of: home furnishing, home appliances, home equipment, office furnishing, office appliances and office equipment.

13. The computer-implemented method according to claim 1, wherein the scanning is performed by a near real-time 3D scanning technique implemented by the MR devices.

14. The computer-implemented method according to claim 1, wherein the feature points are voxels, each voxel having respective unique 3D coordinates.

15. The computer-implemented method according to claim 1, wherein the MR meeting room is persistent.

16. A computerized system for creating a mixed reality meeting room, the system comprising a first MR device, a second MR device and a backend service wherein:
the first MR device is configured to scan a first physical object located in a first physical environment;
the second MR device is configured to scan a second physical object located in a second physical environment the first and second physical environments being spatially different;
wherein the respective MR devices, and/or the backend service is/are further configured to:
during said scanning, generate first and second feature point clouds, of the first and second physical objects, respectively, each one of the first and second feature point clouds comprising a plurality of feature points, each feature point having unique spatial coordinates with respect to the associated physical environment,
apply a feature point detection algorithm to determine candidate anchor portions of each one of the first and second feature point clouds
compare the candidate anchor portions to a reference feature point cloud of a virtual representation of a reference physical object;
derive from among the candidate anchor portions, at least one common anchor portion between the first, second and reference feature point clouds in response to a matching condition of said comparing being met; and
align the first and second feature points clouds such that they coincide with one another with respect to the at least one common anchor portion; and
wherein each one of the first and second MR devices are further configured to render visualization of the MR meeting room based on the aligned feature point clouds, such that a virtual representation of a user of the first MR device is visualized in the MR meeting room with respect to the second physical object, or a virtual representation thereof, and such that a virtual representation of a user of the second MR device is visualized in the MR meeting room with respect to the first physical object, or a virtual representation thereof.

17. The computerized system according to claim 16, wherein the MR meeting room is persistent.

18. The computerized system according to claim 16, wherein the first and second MR devices are selected from the group consisting of: a head mounted display a cave automatic virtual environment or an augmented reality device.

19. A non-transitory computer-readable storage medium comprising instructions, which when executed by a processor device, cause the processor device to perform the functionality of one of the first or second MR device of the method claim 1.

20. A computing device comprising a processor device being configured to perform the functionality of one of the first or second MR device of the method of claim 1.
